(19) United States
(12) Patent Application Publication
(10) Pub. No.: US 2004/0103374 A1
(43) Pub. Date: May 27, 2004

(54) Function extension type browser, browser component, program and recording medium

(75) Inventor: Hiroshi Chishima, Tokyo (JP)

Correspondence Address: SCULLY SCOTT MURPHY & PRESSER, PC, 400 GARDEN CITY PLAZA, GARDEN CITY, NY, 11530

(73) Assignee: NEC Corporation, Tokyo (JP)

(21) Appl. No.: 10/717,867

(22) Filed: Nov. 19, 2003

(30) Foreign Application Priority Data
Nov. 20, 2002 (JP) 2002-336149

(51) Int. Cl. G06F 17/00

(52) U.S. Cl. 715/513

(57) ABSTRACT

When an information service provided by an extended markup language (e.g., proprietary tag is added) is used, an application program capable of processing the extended part is downloaded. The application program obtains document data for using the information service. The document data is converted into structured document information and stored in a document information database. When such an event that a user sets a focus on a predetermined part (e.g., anchor) on a document displayed based on the structured document information takes place, an event information informing unit informs the application program of event information including the type and the part where the event takes place. The application program refers to the structured document information by using a document information manipulation unit, and if the part on which the event takes place is a part related to the extended part (e.g., proprietary tag), performs processing according to the proprietary tag.

### BACKGROUND OF THE INVENTION

1. Field of the Invention

The present invention relates to a function extension technique for browsers installed in mobile terminals or personal computers, and in particular, to a function extension technique for browsers, which is capable of easily coping with information services requiring extension of markup languages or meta-information.

2. Related Art

In a case that a browser installed in a mobile terminal or a personal computer is not provided with a function of using an information service (such as an MPEG4 image reproduction), a service module for using the information service is downloaded first. Then, by using the downloaded service module, the information service is used. This has been performed conventionally (see, for example, the Japanese Patent Application Laid-open No. 2001-265685).

However, with the conventional technique described above, the service module has not been capable of referring to or editing structured document information (information used for displaying a document) managed in the browser, or recognizing a part (such as an anchor) of the document instructed by the user. Thus, an information service which requires to extend a markup language or meta-information itself could not be used.

For example, if the information service is one which requires to extend a markup language using a proprietary tag, processing relating to the proprietary tag must be performed at the service module, since the browser does not support the proprietary tag. However, in the case of a conventional service module, it cannot recognize the fact that the user instructs on a part relating to the proprietary tag in the document, so that the service module cannot perform processing relating to the proprietary tag. Further, there is a problem that with the proprietary tag, it is not assured how the displaying operations of the browser work.

Further, if an information service to be provided is one that requires to extend meta-information (such as an HTTP header), for example, processing relating to the extended HTTP header must be performed at the service module, since the browser does not support the extended HTTP header. However, in the case of a conventional service module, it cannot intervene HTTP communications of the browser itself, so that the service module cannot perform processing relating to the extended HTTP header.

### SUMMARY OF THE INVENTION

An object of the present invention is to make it possible to cope with information services which require to extend markup languages or meta-information.

Therefore, a function extension type browser of the present invention comprises: a document parser unit for converting document data into structured document information according to an instruction from an application program; a document information manipulation unit for enabling the structured document information to be referred from the application program; a browser core unit for displaying a document based on the structured document information according to an instruction from the application program; and an event information informing unit for, when an event relating to the displayed document takes place, informing the application program of event information indicating the type of the event and a part of the document where the event takes place.

Further, the present invention intends that displaying is not to be badly influenced by an expansion of a markup language (for example, an added proprietary tag), or that displaying is to be done in an appropriate format.

Thus, in the present invention, it is desirable that the document information manipulation unit have a function of editing the structured document information according to an instruction from the application program.

Further, in the present invention, the application program may have a function of, when the event information is informed from the event information informing unit, referring to the structured document information by using the document information manipulation unit, obtaining the content of a node relating to the part where the event takes place among the nodes being components of the structured document information, and performing processing according to the type of the event indicated by the informed event information and the obtained content of the node.

Further, in the present invention, the application program may have a function of, when the event information is informed from the event information informing unit, referring to the structured document information by using the document information manipulation unit, obtaining the content of a node relating to the part indicated by the event information among the nodes being components of the structured document information, and when the obtained content of the node relates to a proprietary tag or a proprietary attribute, performing processing in accordance with the obtained content of the node and the type of the event indicated by the event information.

Further, in the present invention, the processing performed in accordance with the obtained content of the node and the type of the event indicated by the informed event information may be voice production processing.

Further, in the present invention, the application program may have: a function of instructing the document information manipulation unit on a node intended to be edited, among the nodes being components of the structured document information, as well as on the content of the editing, and a function of, when the event information is informed from the event information informing unit, referring to the structured document information by using the document information manipulation unit, obtaining the content of a node relating to the part indicated by the event information among the nodes being the components of the structured document information, and performing processing according to the type of the event indicated by the informed event information and the obtained content of the node.

Further, in the present invention, the application program may have: a function of instructing the document information manipulation unit on a node intended to be edited, among the nodes being components of the structured document information, as well as the content of the editing, and a function of, when the event information is informed from the event information informing unit, referring to the structured document information by using the document information manipulation unit, obtaining the content of a node relating to the part indicated by the event information among the nodes being components of the structured document information, and if the obtained content of the node is a proprietary tag or a proprietary attribute, performing processing according to the obtained content of the node and the type of the event indicated by the event information.

Further, in the present invention, the event information informing unit may have a function of, when an event relating to a document to be displayed takes place, informing the application program of event information indicating the type of the event, and the application program may have a function of, when the event information is informed from the event information informing unit, instructing the document information manipulation unit on a node intended to be edited among the nodes of the structured document information corresponding to the document to be displayed, as well as on the content of the editing.

Further, in the present invention, the node intended to be edited may be a node corresponding to a proprietary tag or a proprietary attribute which are uniquely extended, the content of the editing may be to cause the node corresponding to the proprietary tag or the proprietary attribute to be a comment node, and the processing performed according to the proprietary tag or the proprietary attribute may be voice production processing.

Further, in the present invention, the application program may have a function of, when the event information is informed from the event information informing unit, referring to the structured document information by using the document information manipulation unit, obtaining the content of a node corresponding to the part indicated by the event information among the nodes being components of the structured document information, and based on the obtained content, creating meta-information in a format not supported by the function extension type browser.

Further, in the present invention, the application program has: a function of, according to the event information informed from the event information informing unit, creating an HTTP request header in a format not supported by the browser core unit and issuing an HTTP request including the created HTTP request header, and a function of obtaining document data and performing processing relating to an HTTP response header accompanying the document data.

Further, in the present invention, the HTTP response header and the HTTP request header handled by the application program may be an HTTP response header and an HTTP request header relating to cookies.

Further, the present invention may enable document data not supported by the document parser unit to be displayed.

Further, in the present invention, the application program may have a function of analyzing document data in a format not supported by the document parser unit, and based on the analysis result, creating structured document information by using the document information manipulation unit.

### Operation

The function extension type browser of the present invention comprises: a document parser unit for converting document data into structured document information; a document information manipulation unit for enabling the structured document information to be referred from the application program; a browser core unit for displaying a document on the screen according to the structured document information; and an event information informing unit for, when an event relating to the displayed document takes place; informing the application program of event information indicating the type of the event and the part of the document where the event takes place. Therefore, it is possible to use information services which require to extend markup languages or meta-information.

For example, in a case of using an information service which requires to extend a markup language, an application program capable of processing the extended part of the markup language is downloaded. Then, according to an instruction from the application program, the document parser unit converts document data, which is required for using the information service, into structured document information. Then, the browser core unit displays the document according to the structured document information. It should be noted that if the structured document information is edited before displaying is performed in accordance with the structured document information (for example, such processing as causing a node corresponding to a proprietary tag, among the nodes being components of the structured document information, to be a comment node), it is possible to prevent the displaying from being badly influenced by the extended part. Then, when a user instructs on a predetermined part (e.g., an anchor) of the document by a click manipulation or the like, the event information informing unit informs the application program of the part instructed by the user. When the part instructed by the user is informed, the application program refers to the structured document information by using the document information manipulation unit, obtains the content of a node relating to the part instructed by the user among the nodes being components of the structured document information, and if the content corresponds to the extended part (e.g., a proprietary tag) of the markup language, performs processing according to the proprietary tag. Thus, it is possible to cope with an information service which requires to extend a markup language.

Further, in a case of using an information service which requires to extend meta-information, an application program capable of processing the extended part of the meta-information is downloaded. Then, the application program obtains document data, and performs processing relating to the meta-information (e.g., an HTTP response header relating to cookies) accompanying the document data. Then, when an event such as a click manipulated by the user takes place and is informed from the event information informing unit, the application program performs processing of the event (e.g., issuing an HTTP request for obtaining another document data). At this time, the application program performs processing relating to the meta-information (e.g., creating an HTTP request header relating to cookies). Therefore, according to this structure, it is possible to easily cope with an information service that requires to extend meta-information of a document.

### BRIEF DESCRIPTION OF THE DRAWINGS

FIG. 1 is a block diagram showing an embodiment of the present invention;

FIG. 2 is a flowchart showing an example of processing when an information service requiring an extension of a markup language is used;

FIG. 3 is a diagram showing an example of a structure of an application program 4a which is to be downloaded when an information service requiring an extension of a markup language is used;

FIG. 4 is a diagram showing an example of processing with a specific example when an information service requiring an extension of a markup language is used;

FIG. 5 is a flowchart showing an example of processing performed at a proprietary tag processing unit 44a in the application program 4a;

FIG. 6 is a diagram showing an example of editing a document;

FIG. 7 is a diagram showing a content of editing structured document information, which is performed at the time of editing shown in FIG. 6;

FIG. 8 is a flowchart showing an another example of processing when an information service requiring an extension of a markup language is used;

FIG. 9 is a flowchart showing an example of processing when an information service requiring an extension of meta-information is used;

FIG. 10 is a diagram showing an example of a structure of an application program 4b which is to be downloaded when an information service requiring an extension of meta-information is used;

FIG. 11 is a flow chart showing the step S93 of FIG. 9 in detail;

FIG. 12 is a diagram showing an example of processing with a specific example when an information service requiring an extension of meta-information is used;

FIG. 13 is a flowchart showing an example of processing in a case that document data required for using an information service is data other than HTML;

FIG. 14 is a diagram showing an example of an application program 4c to be downloaded in a case that document data required for using an information service is data other than HTML;

FIG. 15 is a diagram showing an example of processing with a specific example in a case that document data required for using an information service is data other than HTML; and

FIG. 16 is a block diagram showing another embodiment of the present invention.

### PREFERRED EMBODIMENTS OF THE INVENTION

Next, preferred embodiments of the invention will be described in detail with reference to the drawings.

### Structure

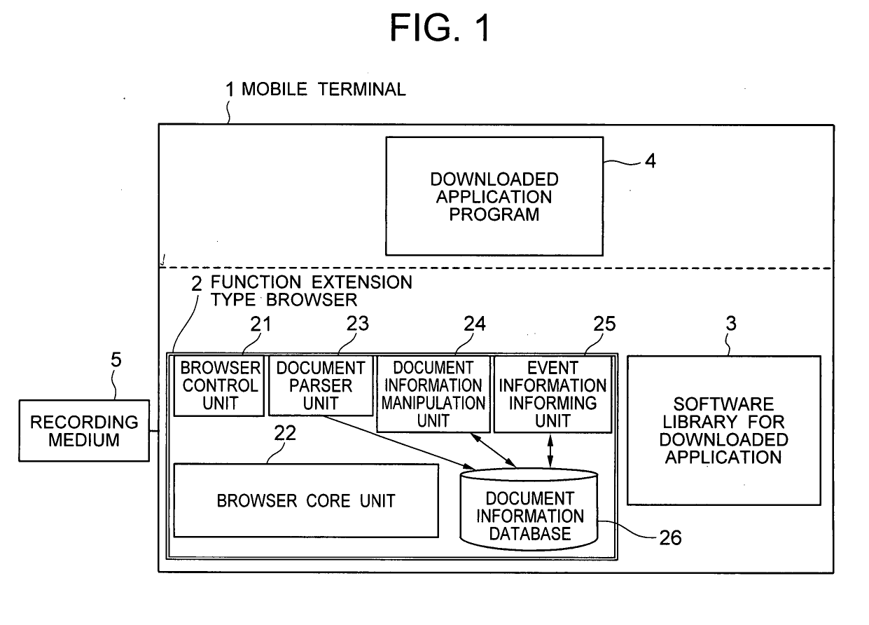

FIG. 1 is a block diagram showing an embodiment of the present invention. The figure shows an example of the structure of a mobile terminal 1, into which a function extension type browser 2 according to the present invention is installed. Although the function extension type browser 2 is installed in the mobile terminal 1, it may be installed in a personal computer.

Referring to FIG. 1, the mobile terminal 1 comprises the function extension type browser 2, an application program 4 which is downloaded, a software library 3 for the downloaded application, and a recording medium 5. The function extension type browser 2, the application program 4, and the software library 3 are operated by a micon (computer), not shown, incorporated in the mobile terminal 1 to thereby exhibit respective functions.

The application program 4 is downloaded into the mobile terminal 1 for using an information service which requires an extension of a markup language or meta-information. The application program 4 is stored in a memory in the mobile terminal 1. The memory in the mobile terminal 1 is a general one, so that it is not shown in the figures.

The function extension type browser 2 comprises a browser control unit 21, a browser core unit 22, a document parser unit 23, a document information manipulation unit 24, an event information informing unit 25, and a document information database 26.

The mobile terminal 1 provides the downloaded application program 4 with the function extension type browser 2 and the software library 3 as an environment for executing the application.

The software library 3 for the downloaded application is a library which provides the application program 4 with various functions such as a function of communicating via a radio network or an infrared device, a graphic function, a file system function, a function of manipulating character strings, a voice synthesis function, and the like.

The browser core unit 22 has basic functions as a browser, such as functions of obtaining document data, performing layout, displaying, scrolling, selecting operations, and the like.

The document parser unit 23 has a function of converting document data into structured document information, and storing the information in the document information database 26.

The document information manipulation unit 24 has an interface function with the document information database 26, to thereby provide both the application program 4 and the browser core unit 22 with a function of referring to the structured document information and a function of editing for performing such as addition of information and creation.

The event information informing unit 25 has a function of, when an event takes place by a user manipulation such as a focus transfer or a click in a document displayed on the display of the mobile terminal 1, informing the application program 4 of event information including the type of the event and the part of the document where the event takes place. Further, the event information informing unit 25 has a function of, when an event related to a document intended to be displayed (for example, an event indicating that downloading of document data for displaying the document has completed) takes place, informing the application program 4 of event information indicating the type of the event.

The browser control unit 21 has a function of transmitting operational instructions from the application program 4 to the browser core unit 22, and transmitting instructions from the browser core unit 22 to the application program 4. It should be noted that the operational instructions from the application program 4 include, at least, an instruction of creating structured document information using the document parser unit 23 and the document information manipulation unit 24 and an instruction of designating and displaying the structured document information stored in the document information database 26.

The recording medium 5 may be a disc, a semiconductor memory, or other recording media, into which a program for starting the function extension type browser 2 on the mobile terminal 1 having CPU (not shown) is recorded. The CPU, not shown, reads the program recorded in the recording medium 5 and executes the program to thereby activate the function extension type browser 2 so as to cause the function extension type browse 2 to exhibit functions as the browser control unit 21, the browser core unit 22, the document parser unit 23, the document information manipulation unit 24 and the event information informing unit 25.

### Operations

Next, operations of the embodiment of the present invention will be described in detail. First, an operation in the case of using an information service provided by an extended markup language (extended HTML) to which a proprietary tag is added.

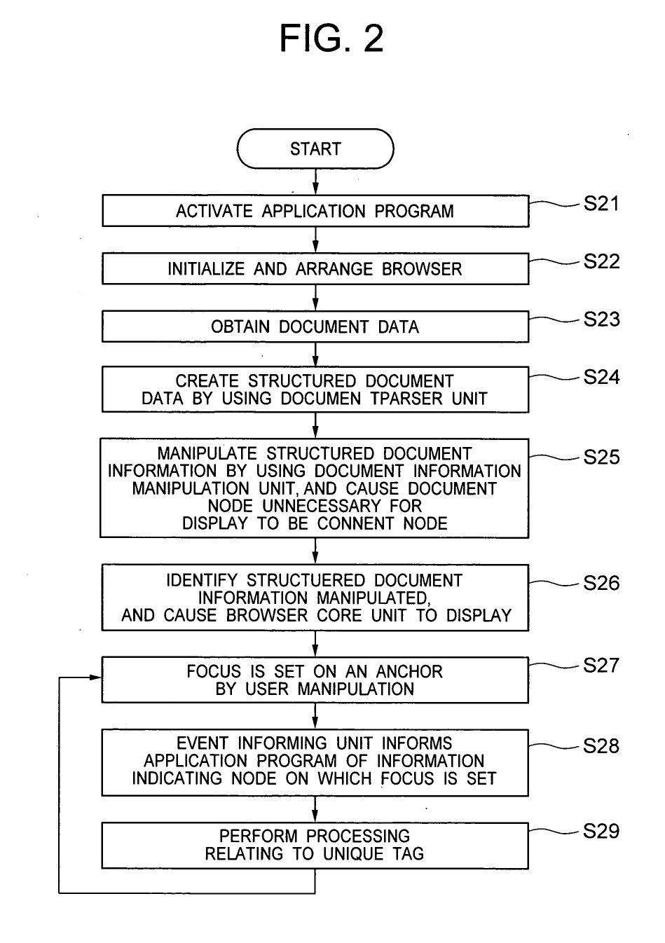

First, the user of the mobile terminal 1 downloads an application program 4a to the mobile terminal 1 for using an information services provided by an extended HTML to which a proprietary tag is added, and activates the application program 4a at the mobile terminal 1 (FIG. 2, Step S21).

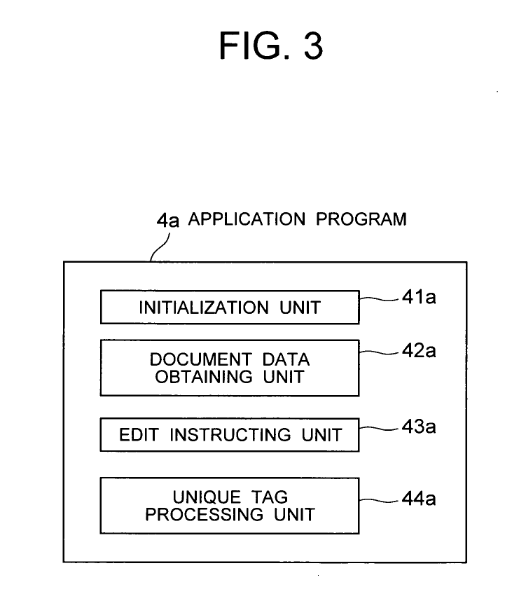

The application program 4a to be downloaded here has, for example, functions as an initialization unit 41a, a document data obtaining unit 42a, an edit instruction unit 43a, and a proprietary tag processing unit 44a, as shown in FIG. 3.

The initialization unit 41a has a function of initializing the function extension type browser 2 and a function of designating the size and the position of a screen used by the function extension type browser 2.

The document data obtaining unit 42a has a function of downloading document data (document data in which a proprietary tag is used) for using an information service to the mobile terminal 1 and instructing the document parser unit 23 to create structured document information corresponding to the downloaded document data, or the like.

The edit instruction unit 43a has a function of instructing the document information manipulation unit 24 of a node intended to be edited among the nodes constituting the structured document information and instructing the content of the editing.

The proprietary tag processing unit 44a has the following functions, which will be explained subsequently. A first function is, when event information is informed from the event information informing unit 25, to determine whether the type of the event indicated by the event information is the one which enables processing by the proprietary tag. A second function is, when the event type is the one which enables the proprietary tag, to find out whether the proprietary tag exists in a part of the document related to the part indicated by the event information. A third function is, when the proprietary tag exists, to find out whether the proprietary tag is the one which is to be enabled in the case of the event type informed this time. A forth function is, if the proprietary tag is the one which is to be enabled in the case of the event type informed this time, to perform processing according to the proprietary tag. It should be noted that if there are plural types of proprietary tags and the event types are different depending on the proprietary tags, it is required that the aforementioned functions be provided to the proprietary tag processing unit 44a. In contrast, in a case that there is only one type of proprietary tag or in a case that there is only one event type which enables proprietary tags although plural types of proprietary tags exist, the proprietary tag processing unit 44a could have a function of determining, when event information is informed form the event information informing unit 25, whether the event type indicated by the event information is the one which enables processing by the proprietary tag. Further, if the event type is the one which enables the proprietary tag, the proprietary tag processing unit 44a could have a function Of finding out whether the proprietary tag exists in a part of the document related to the part indicated by the event information, and when it exists, a function of performing processing according to the proprietary tag.

When activated, the application program 4a first initializes the function extension type browser 2 using the initialization unit 41a, and identifies, using the information of the software library 3, the size and the position of the screen to be used by the function extension type browser 2 (step S22).

Next, the application program 4a obtains, using the document data obtaining unit 42a, document data to be used in the information service, and stores the document data in the storage, not shown, of the mobile terminal 1 (step S23). Any method of obtaining the document data may be acceptable. For example, there may be a method of using the HTTP communication function provided by the software library 3, a method of obtaining via a file system, or a method of using the document data obtaining function provided by the browser core unit 22.

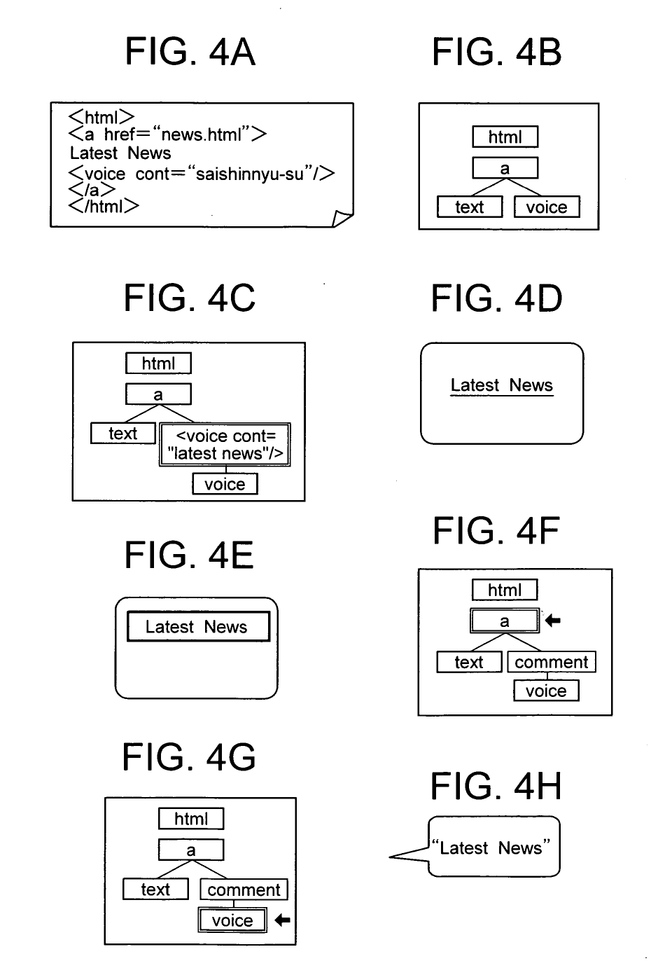

In FIG. 4(A), an example of the document data obtained in the step S23 is shown. In the figure, <voice cont=“latest news”/> is a proprietary tag which is newly added. This proprietary tag is arranged between the tags <a> and </a>. When a focus is set on a character string indicated with the tags <a> and </a> (in this example, “Latest News”), the character string “latest news”, quoted in the proprietary tag, is voice-synthesized and output.

Then, the document data obtaining unit 42a in the application program 4a passes the document data obtained in the step S23 to the document parser unit 23 in the function extension type browser 2, and instructs to create structured document information. With this step, the document parser unit 23 creates the structured document information shown in FIG. 4(B), and stores the structured document information in the document information database 26 (step S24).

In FIG. 4(B), although the contents of the nodes are omitted, a node shown as “a” includes information of “<a href=“news.html”>” shown in FIG. 4(A), a node shown as “text” in FIG. 4(B) includes information of “Latest News”, and a node shown as “voice” in FIG. 4(B) includes information of “<voice cont=“latest news”/>∞. In this embodiment, the structured document information is created and stored in the document information database 26 by using the document parser unit 23. However, the application program 4a may create the structured document information by using the document information manipulation unit 24 and store it in the document information database 26.

Then, the edit instruction unit 43a in the application program 4a finds out a node intended to be edited among nodes constituting the structured document information by using the document information manipulation unit 24 in the function extension type browser 2. Further, the edit instruction unit 43a instructs on the found node as a node intended to be edited and also instructs the content of the editing. In this example, the edit instruction unit 43a finds out, by using the document information manipulation unit 24, a node corresponding to the proprietary tag (a node shown as “voice”) as a node intended to be edited, and by adding a comment node as shown in FIG. 4(C), causing the node corresponding to the proprietary tag to be a comment node (step S25).

Next, the edit instruction unit 43a instructs, via the browser control unit 21, the browser core unit 22 to perform displaying based on the structured document information which has been edited in the step S25. With this step, the browser core unit 22 performs displaying according to the structured document information, shown in FIG. 4(c), which has been edited and stored in the document information database 26 (step S26). Consequently, an anchor character string “Latest News” is displayed on the display (not shown) of the mobile terminal 1, as shown in FIG. 4(D).

Then, the user of the mobile terminal 1 sets a focus on the anchor for using the information service, as shown in FIG. 4(E) (step S27).

When the focus is set on the anchor, the event information informing unit 25 informs the application program 4a of event information including information indicating a node corresponding to the anchor on which the focus is set (for example, a node identifier) and information indicating that the type of the event is “focus setting” (step S28). In the case of this example, information indicating that a focus is set on a node with the arrow in FIG. 4(F) (a node corresponding to the tag <a>), and information indicating that the type of the event is “focus setting” are informed to the application program 4a.

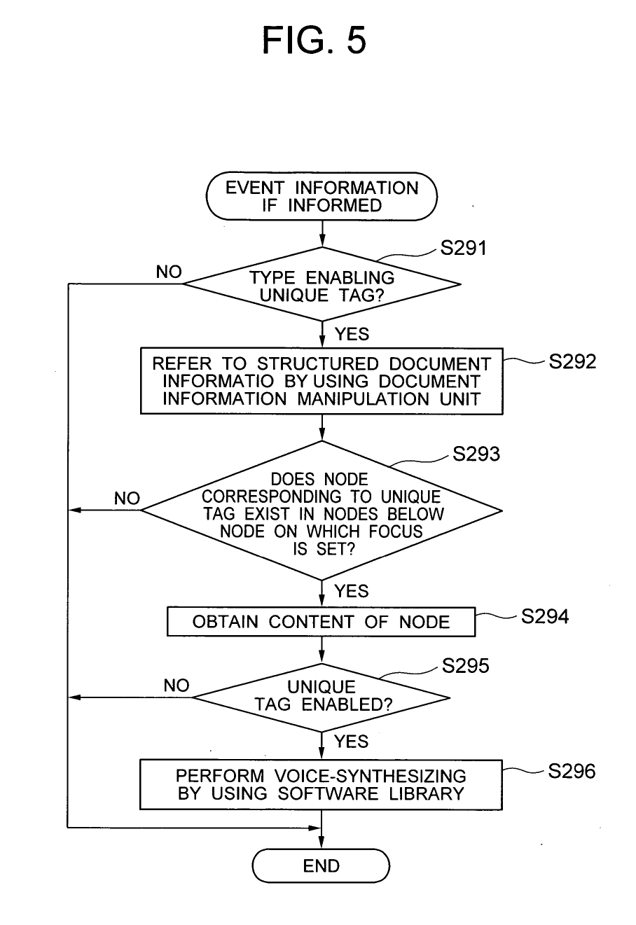

Upon receipt of the information, the proprietary tag processing unit 44a in the application program 4a performs processing relating to the proprietary tag (step S29). The processing of the step S29 will be described in detail with reference to the flowchart of FIG. 5.

The proprietary tag processing unit 44a, when received the event information from the event information informing unit 25, first determines whether the type of the event indicated by the event information is an event type enabling the proprietary tag (FIG. 5, step S291). If it is not an event type enabling the proprietary tag (NO in the step S291), the proprietary tag processing unit 44a ends the processing. In contrast, if it is an event type enabling the proprietary tag (YES in the step S291), the proprietary tag processing unit 44a refers to the structured document information which has been edited and stored in the document information database 26, by using the document information manipulation unit 24 (step S292).

Then, the proprietary tag processing unit 44a finds out whether a node corresponding to the proprietary tag <voice> exists in the nodes below the node corresponding to the anchor on which the focus is set (step S293). That is, in the step S293; the proprietary tag processing unit 44a finds out whether the proprietary tag <voice> exists between the tags <a> and </a> sandwiching the anchor character string on which the focus is set by the user.

If the tag does not exist (NO in the step S293), the proprietary tag processing unit 44a ends the processing. In contrast, if the tag exists (YES in the step S293), the proprietary tag processing unit 44a obtains the content of the node corresponding to the proprietary tag <voice> (in this case, <voice cont=“latest news”/>), as shown in FIG. 4(G). Then, the proprietary tag processing unit 44a determines whether the proprietary tag <voice> is a proprietary tag which is enabled by the event type informed this time, that is, “focus setting” (step S295).

Then, if determined that it is not the proprietary tag to be enabled (NO in the step S295), the proprietary tag processing unit 44a ends the processing. In contrast, if determined that it is the proprietary tag to be enabled (YES in the step S295), the proprietary tag processing unit 44a voice-synthesizes the character string “latest news” within the obtained content by using the function of the software library 3, and outputs it (step S296). These are the details of the processing performed by the proprietary tag processing unit 44a in the step S29.

Then, when the user of the mobile terminal 1 sets a focus on another anchor character string (an anchor character string related to a proprietary tag not shown in the example of FIG. 4) in the document, the same processing as aforementioned is performed (steps S27 to S29). After these steps, when the user clicks an anchor character string “Latest News”, for example, the event information is informed from the event information informing unit 25 to the application program 4a. Subsequently, the document data obtaining unit 42a in the application program 4a refers to the structured document information and obtains the document from “news.html”. Then, the document data obtaining unit 42a creates structured document information using the document parser unit 23 (step S24). After this step, the same processing as aforementioned are performed (steps S25 to S29).

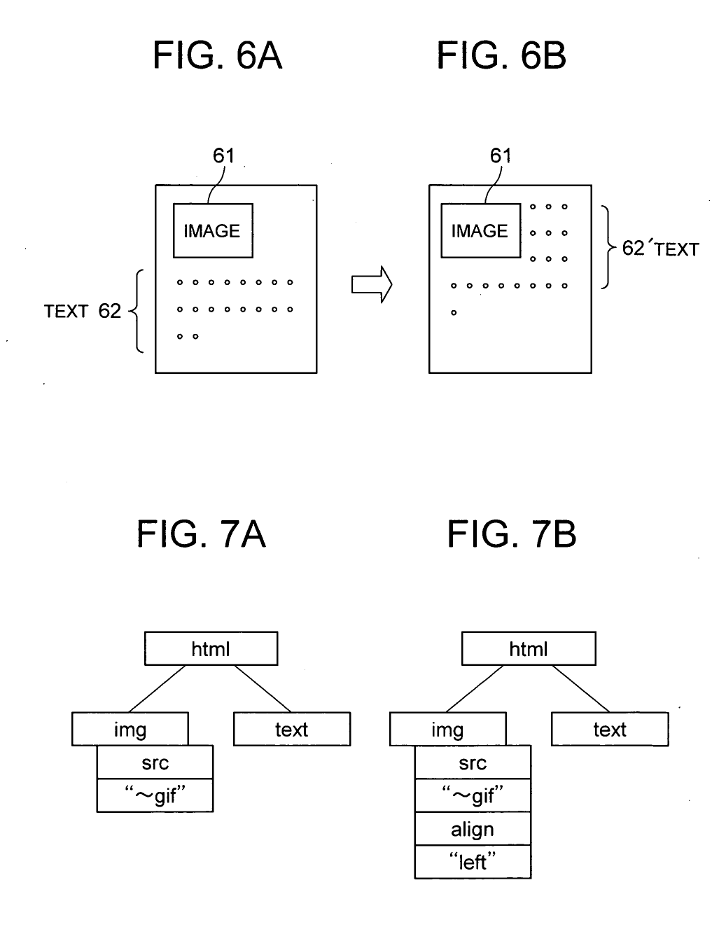

In the description above, edit processing of structured document information, which is performed by the application program 4a using the document information manipulation unit, has been described with an example that a node relating to a proprietary tag is caused to be a comment node. However, another edit processing may be performed. For example, a page like one in which text 62 exists under an image 61 as shown in FIG. 6(A) may be edited to such a page in which the text 62 also exits on the right side of the image 61 as shown in FIG. 6(B). In this case, the application program 4a edits structured document information such as one shown in FIG. 7(A) to one shown in FIG. 7(B) by using the document information manipulation unit 24.

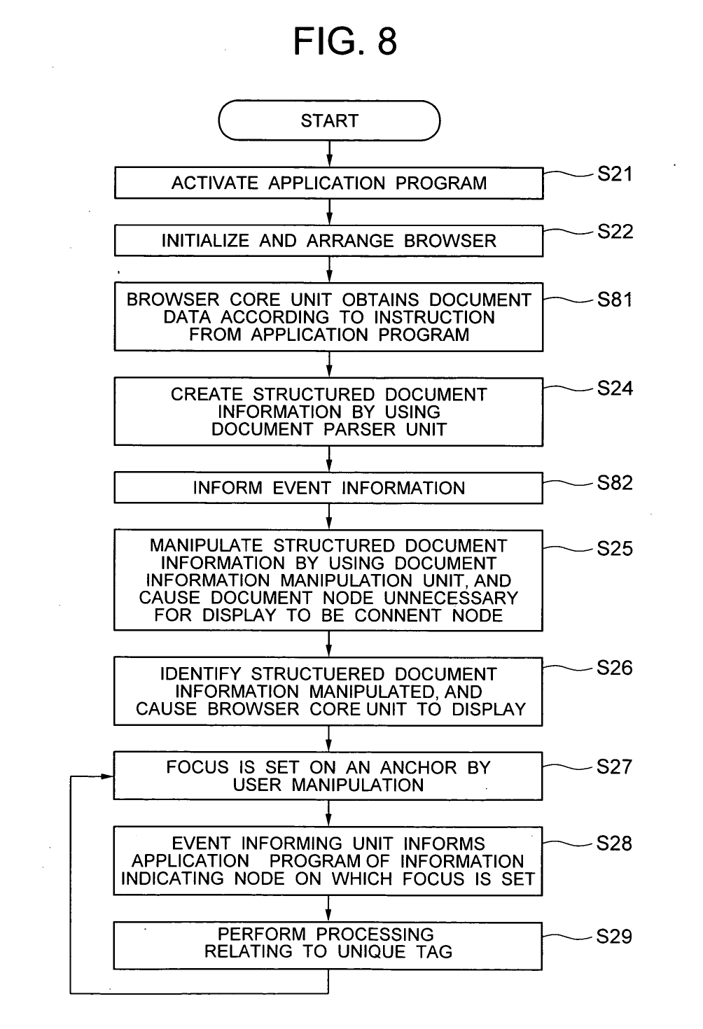

Next, another embodiment in a case of using an information service provided by the extended markup language (extended HTML) to which a proprietary tag is added will be described with reference to the flowchart of FIG. 8.

As same as the embodiment shown in FIG. 2, the application program 4a is activated and the browser is initialized and arranged (FIG. 8, steps S21, S22). Then, the document data obtaining unit 42a instructs the browser core unit 22 via the browser control unit 21 to obtain document data. At this time, the document data obtaining unit 42a instructs the browser core unit 22 on the URL for obtaining the document data. With this instruction, the browser core unit 22 obtains the document data from the URL (step S81). Then, the browser core unit 22 creates structured document information by using the document parser unit 23, and stores it in the document information database 26 (step S24). Then, the event information informing unit 25 informs the application-program 4a of the event information (step S82). This event information includes information indicating that the type of the event is “downloading of document data”. Upon receipt of the information, the edit instruction unit 43a in the application program 4a edits the structured document information corresponding to the document data which has been downloaded by using the document information manipulation unit 24 (step S25). The subsequent processing is same as that of the embodiment shown in FIG. 2.

Although it has not been discussed in the description above, if the proprietary tag in the explanation of FIG. 2 and FIG. 8 is read as a tag including a proprietary attribute (a uniquely extended attribute which does not exist in the current markup language), it is possible to use an information service using a proprietary attribute.

Next, an operation in a case of using an information service, which must use an HTTP header in a format not supported by the function extension type browser 2 (extended meta-information), will be described.

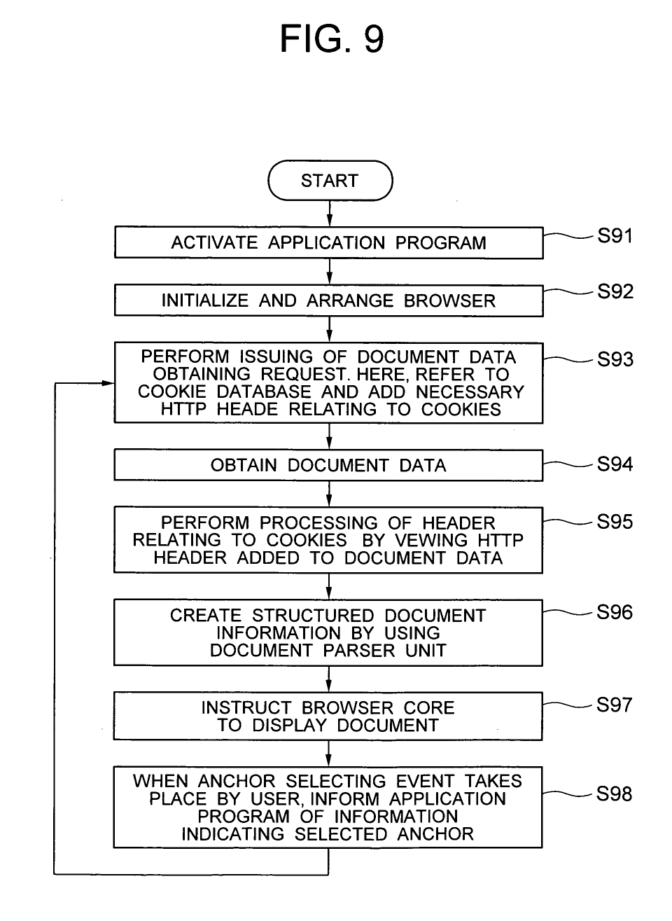

When a user of the mobile terminal 1 uses an information service which must use an HTTP header in a format not supported by the function extension type browser 2 (in this case, assuming an HTTP header related to cookies), the user first downloads an application program 4b required for using the information service, and activates the application program 4b (FIG. 9, step S91).

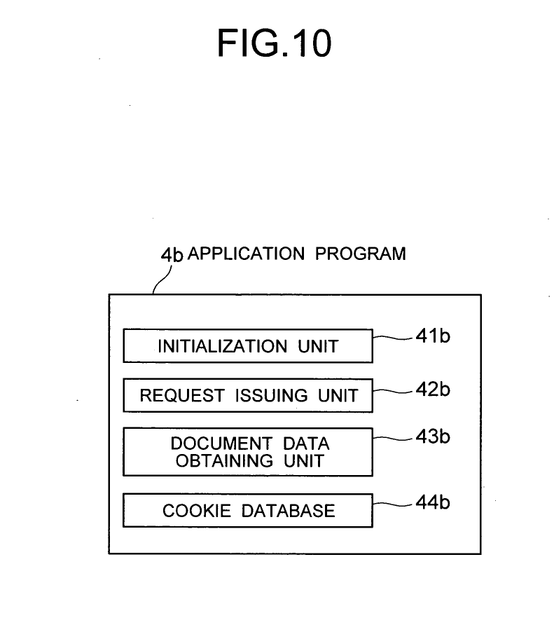

Here, the application program 4b to be downloaded includes functions, for examples, as an initialization unit 41b, a request issuing unit 42b, a document data obtaining unit 43b, and a cookie database 44b, as shown in FIG. 10.

The initialization unit 41b has a function of initializing the function extension type browser 2 and a function of identifying the size and the position of a screen used by the function extension type browser 2.

The request issuing unit 42b has a function of, when informed of information indicating an anchor clicked by the user from the event information informing unit 25 in the function extension type browser 2, creating and issuing a document data obtaining request. The document data obtaining request is a request for obtaining document data identified by the anchor clicked by the user, the HTTP header of which includes information necessary for performing processing relating to the cookies.

The document data obtaining unit 43b has a function of obtaining document data which is transmitted responding to the document data obtaining request issued by the request issuing unit 42b and performing processing related to the cookies according to the HTTP header added to the document data, a function of instructing the document parser unit 23 to create structured document information corresponding to the document data, and the like.

The cookie database 44b stores cookie information.

The application program 4b, when activated, first initializes the function expansion type browser 2 by using the initialization unit 41b, and indicates the size and the position of a screen used by the function expansion type browser 2, then instructs the request issuing unit 42b to start processing (step S92).

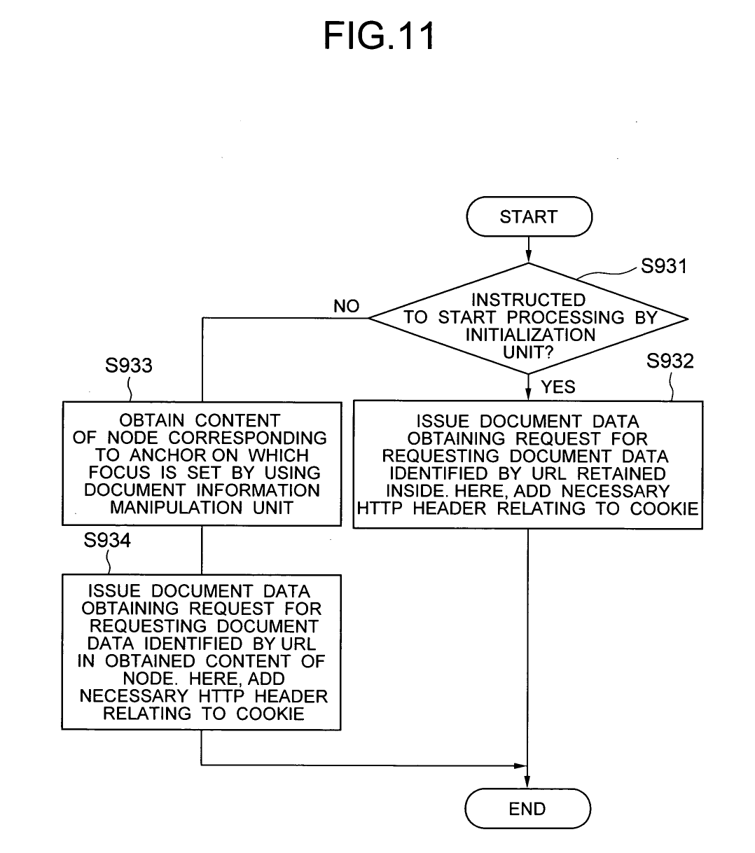

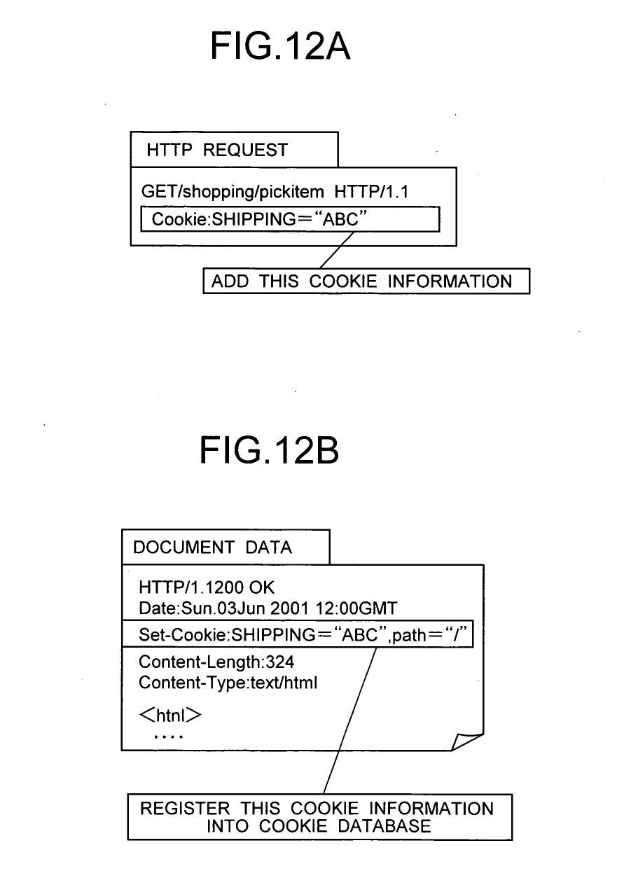

The request issuing unit 42b, when instructed from the initialization unit 41b to start processing, perform processing for issuing the document data obtaining request of the step S93. FIG. 11 is a flowchart-showing the details of the processing performed in the step S93. The request issuing unit 42b, when instructed from the initialization unit 41b to start processing (FIG. 11, YES in the step S931), issues a document data obtaining request with which transmitting of document data necessary for using the information service data (as for a URL to identify this document data, a URL retained within the request issuing unit 42b is used) is requested to the Web server (not shown). Here, the request issuing unit 42b refers to the cookie database 44b retained in the application program 4b and adds information necessary for cookie processing to the HTTP request header (step S932). FIG. 12(A) shows an example of a document data obtaining request issued here.

When received the document data from the Web server responding to the document data obtaining request, the document data obtaining unit 43b obtains the document data. Further, the document data obtaining unit 43b performs processing of the header relating to the cookies based on the HTTP header added to the obtained document data (that is, registering into the cookie database 44b retained in the application program 4b)(steps S94, S95). FIG. 12(B) shows an example of the document data obtained here and an example of the cookie information to be registered in the cookie database 44.

Then, the document data obtaining unit 43c instructs the document parser unit 23 to convert the document data obtained in the step S94 into structured document information. According to this instruction, the document parser unit 23 converts the document data into the structured document information, and stores it in the document information database 26 (step S96).

Then, the document data obtaining unit 43b instructs the browser core unit 22, via the browser control unit 21, to perform displaying in accordance with the structured document information stored in the document information database 26. With this instruction, the browser core unit 22 displays the document on the display of the mobile terminal 1 according to the structured document information (step S97).

Then, when the user of the mobile terminal 1 selects an anchor within the document displayed on the display of the mobile terminal 1, the event information informing unit 25 informs the application program 4b of event information indicating that a node corresponding to the anchor is selected (step S98).

Upon receipt of this information, the request issuing unit 42b in the application program 4b performs processing for issuing the document data obtaining request of the step S63. The processing performed here in the request issuing unit 42b will be described in detail with reference to FIG. 11. When information indicating a node is informed from the event information informing unit 25 (FIG. 11, NO in the step S931), the request issuing unit 42b refers to the document information database 26 by using the document information manipulation unit 24, and obtains the content of the node indicated by the information (step S933). Then, the request issuing unit 42b creates and transmits a document data obtaining request for obtaining the document data identified by the URL in the obtained content. Here, the request issuing unit 42b refers to the cookie database 44b retained in the application program 4b and adds information necessary for performing cookie processing to the HTTP header (step S934).

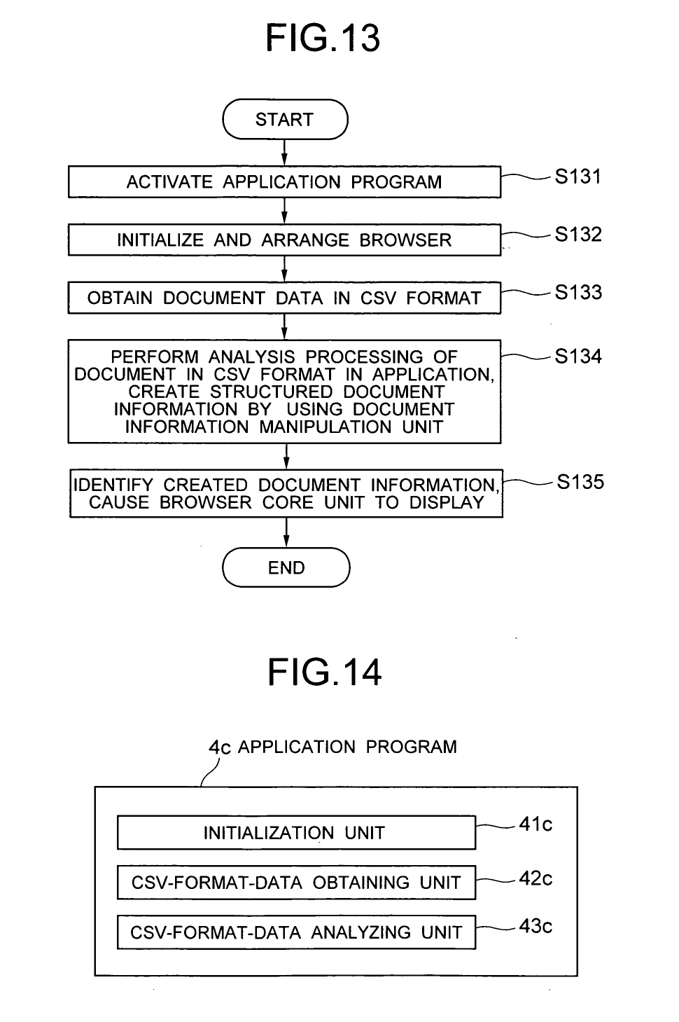

Next, an operation in the case that the document data required for using the information service is data other than HTML (in this case, assuming data in the csv format) will be described with reference to the flowchart of FIG. 13.

First, a user of the mobile terminal 1 downloads an application program 4c required for using an information service which uses document data in the csv format, and activates it (FIG. 13, step S131).

Here, the application program 4c to be downloaded includes an initialization unit 41c, a csv-format-data obtaining unit 42c, and a csv-format-data analyzing unit 43c, as shown in FIG. 14.

The initialization unit 41c has a function of initializing the function extension type browser 2, and a function of identifying the size and the position of a screen used by the function extension type browser 2.

The csv-format-data obtaining unit 42c has a function of obtaining data in the csv format.

The csv-format-data analyzing unit 43c has a function of analyzing data in the csv-format-data obtained by the csv-format-data obtaining unit 42c, and based on the analysis, creating structured document information by using the document information manipulation unit 24.

The application program 4c, when activated, first initializes the function extension type browser 2 by using the initialization unit 41c, and determines the size and the position of a screen to be used by the function extension type browser 2 (step S132).

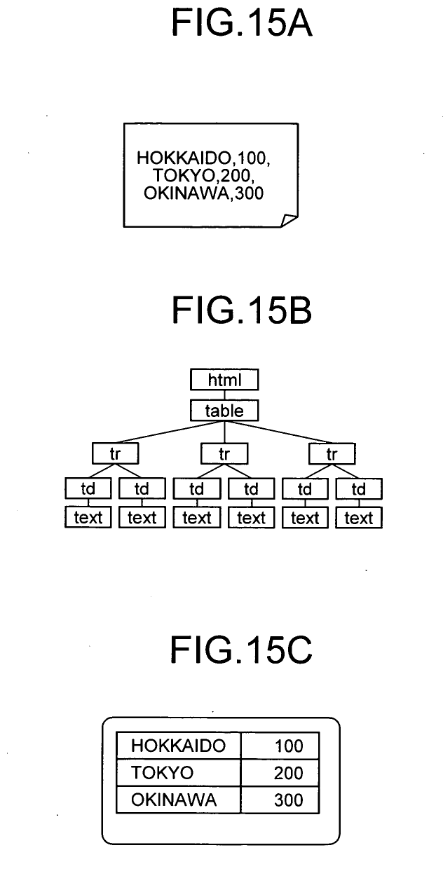

Then, the application program 4c obtains the document data of the csv format by using the csv-format-data obtaining unit 42c (step S133). FIG. 15(A) shows an example of the document data to be obtained here. It should be noted that any method of obtaining the document data, for example, a method of using an infrared communication function provided by the software library 3, may be accepted.

Then, the application program 4c analyzes the document data of the csv format obtained in the step S133 by using the csv-format-data analyzing unit 43c. Further, the application,program 4c creates structured document information in such a format that the application program 4c desires to display, as shown in FIG. 15(B), by using the document information manipulation unit 24, and stores it in the document information database 26 (step S134).

Then, the csv-format-data analyzing unit 43c in the application program 4c instructs the browser core unit 22, via the browser control unit 21, to perform displaying in accordance with the structured document information stored in the document information database 26. With this instruction, the browser core unit 22 displays the document as shown in FIG. 15(C) (step S135).

### Another Embodiment

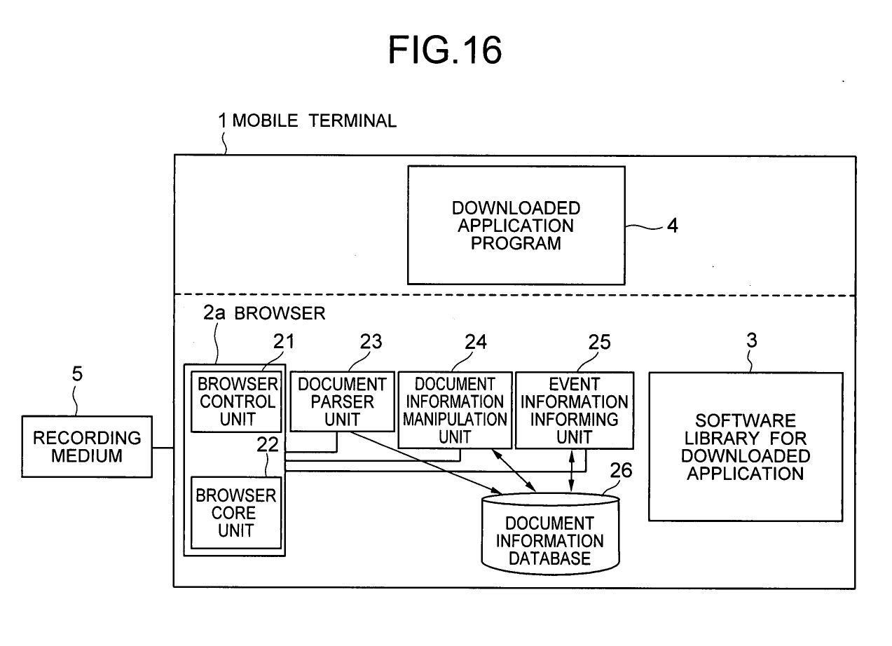

FIG. 16 is a diagram showing the structure of another embodiment according to the present invention. In the embodiment shown in FIG. 1, the function extension type browser 2 includes the browser control unit 21, the browser core unit 22, the document parser unit 23, the document information manipulation unit 24, the event information informing unit 25 and the document information database 26. In the present embodiment shown in FIG. 16, on the other hand, the browser 2a only includes the browser control unit 21 and the browser core unit 22. The document parser unit 23, the document information manipulation unit 24, the event information informing unit 25 and the document information database 26 are independent of the browser 2a.

### Effects

A first effect of the present invention is to easily cope with information services which require to extend markup languages.

The reasons are as follows. The function extension type browser includes a document parser unit for converting document data into structured document information, a document information manipulation unit for enabling the structured document information to be referred from an application program, a browser core unit for displaying a document on a screen according to the structured document information, and an event information informing unit for informing the application program of a part manipulated by the user on the document, so that the function extension type browser can perform processing in association with an application program which is capable of processing the extended part (eg., an added proprietary tag) of a markup language. In other words, since the function extension type browser includes the event information informing unit, when a part (eg., an anchor) of the document is instructed by the user, it may inform the application program, capable of processing the extended part of the markup language, of information indicating the part instructed by the user. Further, since the function extension type browser includes the document information manipulation unit, the application program receiving the information can refer to the structured document information. If the part instructed by the use corresponds to the extended part, the application program further perform processing corresponding to the extended part.

A second effect is that the function extension type browser is easily capable of coping with information services which require to extend meta-information.

The reasons are as follows. The function extension type browser includes a document parser unit for converting document data into structured document information, a document information manipulation unit for enabling the structured document information to be referred to from the application program, a browser core unit for displaying a document on a screen according to the structured document information, and an event information informing unit for informing the application program of a part manipulated by the user on the document, so that the function extension type browser can perform processing in association with an application program which is capable of processing the extended part of the meta-information. That is, since the browser is instructed to display after the application program obtains document data, processing of the meta-information, which is in a format not supported by the function extension type browser (for example, an HTTP header related to the cookies), can be performed during this period. Further, since the function extension type browser includes the event information informing unit, when a part (eg., an anchor) of the document is instructed by the user, it can inform the application program of information indicating the part instructed by the user. Further, since the browser includes the document information manipulation unit, the application program receiving the information can refer to structured document information, obtain the content of a node corresponding to the part instructed by the user, and based on the obtained content, create meta-information in a format not supported by the function extension type browser (eg., HTTP header related to the cookies).

A third effect is that the function extension type browser is capable of easily coping with document data required for using information services even when the data is in a format not supported by the function extension type browser itself.

The reason is that an application program can analyze document information in a format not supported by the function extension type browser, and based on the analysis result, create structured document information in a display format desired by the application program by using the document information manipulation unit, and make the browser display it.

A forth effect is that a plurality of information services which require to extend markup languages or meta-information can be used.

The reason is that the function extension type browser is provided as a component, so that it can be used by a plurality of application programs.

What is claimed is:

1. A function extension type browser comprising:
a document parser unit for converting document data into structured document information according to an instruction from an application program;
a document information manipulation unit for enabling the structured document information to be referred from the application program;
a browser core unit for displaying a document based on the structured document information according to an instruction from the application program;
an event information informing unit for, when an event relating to a displayed document takes place, informing the application program of event information indicating a type of the event and a part of the document where the event takes place.

2. The function extension type browser as claimed in claim 1, wherein the application program is a program to be downloaded when a function is extended.

3. The function extension type browser as claimed in claim 1, wherein the document information manipulation unit has a function of editing the structured document information according to an instruction from the application program.

4. The function extension type browser as claimed in claim 1, wherein the application program has a function of, when the event information is informed from the event information informing unit, referring to the structured document information by using the document information manipulation unit, obtaining a content of a node relating to the part where the event takes place among nodes being components of the structured document information, and performing processing according to the type of the event indicated by the informed event information and the obtained content of the node.

5. The function extension type browser as claimed in claim 1, wherein the application program has a function of, when the event information is informed from the event information informing unit, referring to the structured document information by using the document information manipulation unit, obtaining a content of a node relating to the part indicated by the event information among nodes being components of the structured document information, and when the obtained content of the node relates to a proprietary tag or a proprietary attribute, performing processing in accordance with the obtained content of the node and the type of the event indicated by the event information.

6. The function extension type browser as claimed in claim 5, wherein the processing performed in accordance with the obtained content of the node and the type of the event indicated by the event information is voice production processing.

7. The function extension type browser as claimed in claim 3, wherein the application program has:
a function of instructing the document information manipulation unit on a node intended to be edited, among nodes being components of the structured document information, as well as a content of the editing, and
a function of, when the event information is informed from the event information informing unit, referring to the structured document information using the document information manipulation unit, obtaining a content of a node relating to the part indicated by the event information among the nodes being the components of the structured document information, and performing processing according to the type of the event indicated by the informed event information and the obtained content of the node.

8. The function extension type browser as claimed in claim 3, wherein the application program includes:
a function of instructing the document information manipulation unit on a node intended to be edited, among nodes being components of the structured document information, as well as a content of the editing, and
a function of, when the event information is informed from the event information informing unit, referring to the structured document information using the document information manipulation unit, obtaining a content of a node relating to the part indicated by the event information among the nodes being the components of the structured document information, and if the obtained content of the node is a proprietary tag or a proprietary attribute which are uniquely extended, performing processing according to the obtained content of the node and the type of the event indicated by the event information.

9. The function extension type browser as claimed in claim 8, wherein
the event information informing unit has a function of, when an event relating to a document to be displayed takes place, informing the application program of event information indicating a type of the event, and
the application program has a function of, when the event information is informed from the event information informing unit, instructing the document information manipulation unit on a node intended to be edited among nodes being components of the structured document information corresponding to the document to be displayed as well as a content of the editing.

10. The function extension type browser as claimed in claim 8, wherein
the node intended to be edited is a node corresponding to the proprietary tag or the proprietary attribute which are uniquely extended,
the content of the editing is to cause the node corresponding to the proprietary tag or the proprietary attribute to be a comment node, and
the processing performed according to the proprietary tag or the proprietary attribute is voice production processing.

11. The function extension type browser as claimed in claim 9, wherein
the node intended to be edited is a node corresponding to the proprietary tag or the proprietary attribute which are uniquely extended,
the content of the editing is to cause the node corresponding to the proprietary tag or the proprietary attribute to be a comment node, and
the processing performed according to the proprietary tag or the proprietary attribute is voice production processing.

12. The function extension type browser as claimed in claim 1, wherein the application program has a function of, when the event information is informed from the event information informing unit, referring to the structured document information by using the document information manipulation unit, obtaining a content of a node corresponding to the part indicated by the event information among nodes being components of the structured document information, and based on the obtained content, creating meta-information in a format not supported by the function extension type browser.

13. The function extension type browser as claimed in claim 1, wherein the application program has:
a function of, according to the event information informed from the event information informing unit, creating an HTTP request header in a format not supported by the browser core unit and issuing an HTTP request including the created HTTP request header, and a function of obtaining document data and performing processing relating to an HTTP response header accompanying the document data.

14. The function extension type browser as claimed in claim 13, wherein the HTTP response header and the HTTP request header handled by the application program are an HTTP response header and an HTTP request header relating to a cookie.

15. The function extension type browser as claimed in claim 1, wherein the application program has a function of analyzing document data in a format not supported by the document parser unit, and based on an analysis result, creating structured document information by using the document information manipulation unit.

16. The function extension type browser as claimed in claim 1, comprising a memory for storing the application program.

17. The function extension type browser as claimed in claim 3, wherein the structured document information which is used by the browser to display the document is edited at the document information manipulation unit.

18. A browser component being components of a function extension type browser, wherein the function extension type browser comprising:
a document information manipulation unit for enabling the structured document information to be referred from the application program;
a browser core unit for displaying a document based on the structured document information according to an instruction from the application program; and
an event information informing unit for, when an event relating to the displayed document takes place, informing the application program of event information indicating a type of the event and a part of the document where the event takes place; wherein
the browser component has a function of converting document data into structured document information according to an instruction from an application program.

19. A browser component being components of a function extension type browser, wherein the function extension type browser comprising:
a document parser unit for converting document data into structured document information according to an instruction from an application program;
a browser core unit for displaying a document based on the structured document information according to an instruction from the application program; and
an event information informing unit for, when an event relating to the displayed document takes place, informing the application program of event information indicating a type of the event and a part of the document where the event takes place; wherein
the browser component has a function of enabling the structured document information to be referred from the application program.

20. A browser component being components of a function extension type browser, wherein the function extension type browser comprising:
a document parser unit for converting document data into structured document information according to an instruction from an application program;
a document information manipulation unit for enabling the structured document information to be referred from the application program; and
a browser core unit for displaying a document based on the structured document information according to an instruction from the application program; wherein
the browser component has a function of when an event relating to the displayed document takes place, informing the application program of event information indicating a type of the event and a part of the document where the event takes place.

21. A browser component being components of a function extension type browser, wherein the function extension type browser comprising:
a document information manipulation unit for enabling structured document information to be referred from the application program and editing the structured document information according to an instruction form the application program;
a browser core unit for displaying a document based on the structured document information edited in the document information manipulation unit according to an instruction from the application program; and
an event information informing unit for, when an event relating to a displayed document takes place, informing the application program of event information indicating a type of the event and a part of the document where the event takes place; wherein
the browser component has a function of converting document data into structured document information according to an instruction from the application program.

22. A browser component being components of a function extension type browser, wherein the function extension type browser comprising:
a document parser unit for converting document data into structured document information according to an instruction from an application program;
a browser core unit for displaying a document based on the structured document information edited according to an instruction from the application program; and
an event information informing unit for, when an event relating to a displayed document takes place, informing the application program of event information indicating a type of the event and a part of the document where the event takes place; wherein
the browser component has a function of enabling the structured document information to be referred from the application program and editing the structured document information according to an instruction from the application program.

23. A browser component being components of a function extension type browser, wherein the function extension type browser comprising:
a document parser unit for converting document data into structured document information according to an instruction from an application program;
a document information manipulation unit for enabling the structured document information to be referred from the application program and editing the structured document information according to an instruction from the application program; and
a browser core unit for displaying a document based on the structured document information edited in the document information manipulation unit according to an instruction from the application program; wherein
the browser component has a function of, when an event relating to a displayed document takes place, informing the application program of event information indicating a type of the event and a part of the document where the event takes place.

24. A program as an electric signal for causing a computer of a terminal to execute
a document parser unit for converting document data into structured document information according to an instruction from an application program;
a document information manipulation unit for enabling the structured document information to be referred from the application program;
a browser core unit for displaying a document based on the structured document information according to an instruction from the application program; and
an event information informing unit for, when an event relating to a displayed document takes place, informing the application program of event information indicating a type of the event and a part of the document where the event takes place.

25. A program as an electric signal for causing a computer of a terminal to execute
a document parser unit for converting document data into structured document information according to an instruction from an application program;
a document information manipulation unit for enabling the structured document information to be referred from the application program and editing the structured document information according to an instruction from the application program;
a browser core unit for displaying a document based on the structured document information according to an instruction from the application program; and
an event information informing unit for, when an event relating to a displayed document takes place, informing the application program of event information indicating a type of the event and a part of the document where the event takes place.

26. A recording medium into which a program, for causing a computer of a terminal to execute the functions as claimed in claims 24, is recorded.

27. A recording medium into which a program, for causing a computer of a terminal to execute the functions as claimed in claims 25, is recorded.
